(19) United States
(12) Patent Application Publication
(10) Pub. No.: US 2006/0067266 A1
(43) Pub. Date: Mar. 30, 2006

(54) Radio control over internet protocol system

(76) Inventors: Douglas Edward Ehlers, Lincoln, NE (US); Perry Bennett Howell, Lincoln, NE (US); Daniel Lee Marsh IV, Lincoln, NE (US)

Correspondence Address: DAVID GEORGE JOHNSON, POST OFFICE BOX 286, AITKIN, MN, 56431, US

(21) Appl. No.: 10/950,619

(22) Filed: Sep. 28, 2004

(51) Int. Cl. H04Q 7/00; H04J 3/12

(52) U.S. Cl. 370/328; 370/522

(57) ABSTRACT

A system for augmenting the transmission of audio and data information from a console (45) to a network (48). The system utilizes a data packet format that permits the detection and capture of relatively more detailed information from raw signal data that may otherwise not be available during the course of standard local and remote radio control operations. The system includes the ability to automatically detect Automatic Numerical Identification (ANI) information from the raw signal for recording or display purposes. The ANI information is stored on and received from a central server (44), thereby eliminating the need for each console (45) to store and access an individual ANI/user cross reference table. The system automatically analyzes the data contained in each packet to differentiate between identification and audio information, thereby reducing the total amount of data processed by eliminating the introduction of audio processing or buffering steps into the nonaudio control and identification data. Bypassing of the network jitter buffer (61) permits multicasting of only a brief packet of control data to ensure reception by all devices on the network (48). Actual audio information present in the raw signal data is detected and used to mute receive path audio packets arriving at the console (45), thereby eliminating the need for a dedicated echo canceller while a console operator is transmitting.

### FIELD OF THE INVENTION

The present invention relates generally to the field of remote control and monitoring of multiple radio channels, and more specifically to a system for dividing audio signals into data packets that can be transferred over a computer network.

### BACKGROUND OF THE INVENTION

Many two way radio users, such as police and fire departments, utilize a multitude of separate radio frequency transceivers that are operated and monitored simultaneously. Typically a central command or dispatch facility exists where multiple operators are required to interact with each radio depending on the priority of the radio traffic. Some transmissions originating with the dispatcher are intended only for some users of some radio frequencies, while other transmissions are intended for virtually all users. A single dispatcher cannot listen to multiple transmissions occurring at exactly the same moment, and so there must be some means of muting or otherwise controlling some receivers while listening to a desired transmission from a selected receiver.

Many tone control consoles and radio adaptors exist which permit a central dispatch facility to help maintain the orderly flow of radio transmission and reception. This technology requires an analog connection between each console and each radio. Each console that is used to control an individual radio is wired in parallel to allow multiple operator positions to monitor and control the same radio. For a large system with multiple console positions and multiple radio channels, an entire rack may be required to supply audio to all interested parties. Due to the loading imposed by multiple consoles residing on a particular circuit, additional bridging hardware may be required, increasing the wiring and tuning needs of the system in order to achieve acceptable performance. The Ethernet based Internet Protocol (IP) network addresses many of these issues and provides for a number of other services that were not previously available.

The Radio over Internet Protocol (RoIP) is a subset of the Voice over Internet Protocol (VoIP). VoIP is a method of dividing analog audio signals into packets that can be transferred over a computer network, as shown, for example, in U.S. Pat. No. 6,452,915, entitled IP-FLOW CLASSIFICATION IN A WIRELESS POINT TO MULTI-POINT (PTMP) TRANSMISSION SYSTEM, issued on Sep. 17, 2002 to Jorgensen. Other examples include U.S. Pat. No. 6,765,931, entitled GATEWAY WITH VOICE, issued on Jul. 20, 2004 to Rabenko et al. and U.S. Pat. No. 6,766,291, entitled METHOD AND APPARATUS FOR CONTROLLING THE TRANSITION OF AN AUDIO SIGNAL CONVERTER BETWEEN TWO OPERATIVE MODES BASED ON A CERTAIN CHARACTERISTIC OF THE AUDIO INPUT SIGNAL, issued on Jul. 20, 2004 to Chu et al.

Packet switching makes more efficient use of available bandwidth than traditional circuit switching. Packet switching divides the transmitted data into packets which can be individually transported from a source node to a destination node where the data can be reassembled. This permits a particular portion of the available spectrum to be shared by many sources and destinations, resulting in a more efficient use of the available bandwidth. Due to the packet centric nature of the Ethernet network, the audio is generally divided into 10 millisecond to 40 millisecond (ms) units of audio which are then compressed and placed onto the Ethernet. The nodes of the network are then free to utilize or ignore any combination of packets. If a particular audio stream is of interest, that stream of audio packets is captured, decompressed, converted to analog data and played on the available speakers, headsets or recording devices

Given the popularity of the Ethernet based network, many companies and agencies already have an existing Local Area Network (LAN). Further, a large number of companies exist to provide Wide Area Network (WAN) connections between sites separated by significant distances. The WAN connections can be used to connect offices that are separated by only blocks or by thousands of miles. WAN links are typically less expensive than a comparable leased analog line, and they are able to transmit more conversations simultaneously.

A compelling reason to base a radio control system on VoIP technology is the simplification of wiring requirements. The need to bring at least one pair of wires per channel to each console is replaced by a single connection to the Ethernet. Since the Ethernet can easily handle dozens of simultaneous connections it can become the sole conduit for all communications requirements.

The Ethernet is itself a network including a low level method for transferring data from one location to another. Source and destination are based on the Machine Access Code (MAC) address which is imbedded in the Ethernet interface. The MAC address is unique for all devices throughout the world and cannot be altered. The Institute of Electrical and Electronic Engineers (IEEE) controls the allocation of the MAC addresses. Data transfer speeds across the Ethernet are between 10 and 100 Megabits per second (Mbps). Higher level communications protocols, such as the Internet Protocol (IP), build upon the foundation provided by the Ethernet specification.

The transmission control protocol/internet protocol (TCP/IP) is the best known protocol for use in computer communications and is the basis for communication via the internet and the World Wide Web (WWW). For each byte of information that is transmitted by a first computer to a second computer, the second computer must return an acknowledgement packet. Additional verification is utilized from the outset of the data transfer session to guarantee the integrity of both ends of the computer connection. The guaranteed nature of such communication imposes a substantial amount of overhead to data communications that is not desirable for audio traffic over a network.

An alternate protocol known as the User Datagram Protocol/Internet Protocol (UDP/IP) has coexisted with TCP/IP as a nonverifying method of data communications. UDP/IP allows a computer to send a packet of data to another computer without the verification sequence required within TCP/IP. The computer that sends the packet receives no confirmation that the packet arrived at its destination. While the loss of packets presents a potential problem, it is usually addressed when the particular UDP application is developed. In the case of VoIP, the loss of a packet which contains only 10 ms to 40 ms of audio is not a problem since the human ear will generally ignore such a small data loss. Additional techniques employed during the packet decoding phase can further reduce human detection of such data losses.

The largest single factor in the loss of UDP/IP packets is network and design and loading. As long as a network is designed with sufficient capacity for all of its intended requirements, packet loss will not be a significant issue. UDP/IP is the preferred choice for VoIP development due to its lower bandwidth overhead and its multicasting ability. Multicast is an extension of UDP/IP that enables one computer to broadcast data packets to multiple recipients, an ideal situation for radio communications where multiple persons monitor a radio. A single VoIP connected radio can be configured to multicast VoIP packets when audio is received. Since the multicast packets can be received by any interested party, all consoles that are monitoring audio can receive, decode and playback the packets. Multicasting greatly reduces the bandwidth requirement on a network. There is no need to regenerate the received audio into a UDP/IP data stream for each individual monitor since a single data stream is monitored by all users.

Implementation of a multicasting system requires adherence to the Internet Group Management Protocol version One (IGMPv1) as defined in Request for Comments 1112 entitled “Host Extensions for IP Multicasting” by Deering (The Internet Society, 1989). IP multicasting is defined as the transmission of an IP datagram to a host group, which is a set of zero or more hosts identified by a single IP destination address. Multicast packets are defined as all packets with a destination address residing between 224.0.0.0 and 239.255.255.255. Some of these addresses are commonly used for internet broadcast audio and are thus not always available. When a computer opens a UDP/IP port within this address range the computer becomes part of the multicast group. By joining the group the computer generates a packet that notifies all of the addresses in the group of a desire to monitor the traffic on that particular multicast address. Routers that receive this notification packet will then forward future packets to the requesting computer.

In addition to joining a multicast broadcast group, clients on the network can also specify a packet Time to Live (TTL). The TTL is the number of routers that each packet will pass through before termination. For example, assume that the Time to Live for a particular broadcasting node on a network is set as three. When a packet is transmitted it will arrive at the first router in the network, which will examine the TTL value in the packet and determine if the packet should be forwarded. Since the TTL value is not zero, the first router forwards the packet but will decrease the packet TTL value to two. The next router will decrement the packet TTL value to one, and the subsequent router will assign the packet a TTL value of zero. The next router to encounter the packet will detect the TTL value of zero and the packet will not be retransmitted. Setting a large TTL value may permit packets to travel from one host computer to another over a larger network, but the larger setting will increase the bandwidth requirements on the network due to the relatively larger number of packets being transferred.

Various radio monitoring and control consoles have been developed which implement the use of multicasting for audio communications in conjunction with radio control functions. These products have suffered from a number of shortcomings that affect their real world performance. For example, telephone line control over the IP network has been accomplished at the dispatch console by using a telephone card employing a Plain Old Telephone System (POTS) interface. While this provides a hardware connection between the PSTN and the IP network, echo canceling is not present, creating a major side tone delay for the remote console. The dispatch console accesses the telephone line over the IP network and a TCP/IP control socket is opened between the dispatch console and the remote console via the telephone card, requesting control of the line to either initiate or answer a call. Using the established socket the dispatch console passes specific information to the remote console that allows it to begin sending audio packets that are decoded and modulated onto the phone line as transmitted audio. Since the telephone hybrid has a feedback path caused by the four wire to two wire conversion, all transmitted audio is received by the dispatch console which begins forwarding VoIP packets to the originating, remote console. The delay inherent in VoIP causes the remote console to receive the transmitted audio as much as 150 ms later.

Other drawbacks of existing equipment include excessive bandwidth use. For example, certain functions, such as frequency selection on remote radios, opening the monitor on the remote radio and activating and deactivating frequency scanning or crosspatch (linking two or more radios together to act as a single radio) are accomplished by sending a stream of packets having a length that is greater than the jitter buffer length.

While guaranteeing that the other parallel consoles will detect and process the command, this method consumes bandwidth and potentially interferes with other audio related functions.

What is needed is a Radio over IP system in which packets are utilized in a manner that reduces bandwidth requirements and increases the functionality of associated radio control and monitoring equipment.

### SUMMARY OF THE INVENTION

The present invention is a system that utilizes Multicasting for all audio communications. Typically, only a single multicast is used for all radio traffic. In addition to a valid multicast address, a port number is utilized which contains an additional two bytes of information that further specifies how data traffic should be processed. The transmit and receive port for each radio channel is assigned a unique address, thereby providing for full duplex communication and requiring only a multicast address. A single console is able to select the particular radio resources available on the network without regard for the resources being utilized by adjacent consoles.

The present invention is a process for augmenting the basic transmission and control of information in conjunction with a typical full featured analog console. The disclosed enhancements include the use of audio activity based muting as a substitute for an echo canceller. Audio received from the phone line is monitored and receive (RX) data packets are only generated when audio activity is detected. This permits control of the push to talk function of any cross patched radios even when audio is present.

A method is disclosed of marking control packets to differentiate them from audio packets, eliminating the need for audio delay lines. Multicast packet burst with redundant transmission is used to operate radio scanning functions and to signal other consoles that a line is in use by a crosspatch. A first special packet is created for the purpose of Automatic Numerical Identification (ANI) at each radio, while a second special packet is created for the purpose of retrieving and broadcasting the ANI information as the alphanumeric user name.

The present invention utilizes a multicast packet burst to indicate an Input/Output (I/O) status change. This permits all console users on the network to observe a status change in real time. The present invention accomplishes positional recording by taking an individual console speaker output and creating a VoIP stream directed via UDP/IP to a network recorder. This permits the recorder to archive exactly what a dispatcher heard at a particular listening position rather than merely archiving all radio traffic. Recording is also provided for radio control functions such as frequency selection, scanning, cross patching and supervisory intervention for both IP and analog based consoles connected to the IP network.

### BRIEF DESCRIPTION OF THE DRAWINGS

FIG. 1 is a block diagram depicting the relationship between two desktop consoles interacting with the same radios according to the principles of the present invention;

FIG. 2 illustrates the use of two pairs of desktop consoles residing at different locations to access the same radios according to the principles of the present invention;

FIG. 3 illustrates the interconnection of four dispatch centers with six radios according to the principles of the present invention;

FIG. 4 is a block diagram of a radio controller interacting with two radios according to the principles of the present invention;

FIG. 5 is a block diagram of an analog console interacting with a radio controller according to the principles of the present invention;

FIG. 6 illustrates the basic packet header configuration of an audio data packet according to the principles of the present invention;

FIG. 7 illustrates the audio packet format according to the principles of the present invention;

FIG. 8 illustrates the automatic numerical information packet format according to the principles of the present invention;

FIG. 9 illustrates the update packet format according to the principles of the present invention;

FIG. 10 illustrates the lookup packet format according to the principles of the present invention;

FIG. 11 is a block diagram depicting the relationship between three desktop consoles interacting with the three radios according to the principles of the present invention;

### DETAILED DESCRIPTION OF THE INVENTION

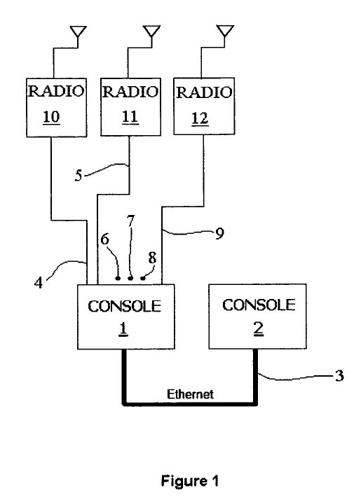

In an exemplary embodiment of a Radio over IP system, a desktop console capable of controlling multiple leased lines includes additional features such as two tone paging, multiple concurrent cross patches, parallel update and an Ethernet port. Referring to FIG. 1, two such consoles 1 and 2 are shown interconnected by Ethernet link 3. Multiple leased line connections 4, 5, 6, 7, 8 and 9 terminate at line cards housed within the console 1. Each telephone line is capable of controlling a separate radio circuit, such as radio circuits 10, 11 and 12. Each radio circuit 10, 11 and 12 may be primarily controlled by tones, but local controls may also be present. Console 1 may be connected via the analog leased line connections 4-9 so as to have access to each radio 10-12, thereby providing complete control of each radio from a single dispatch position. The console 1 can serve as both an analog controller and as a gateway for other IP connections. All audio that is received or transmitted from console 1 is also available via the Ethernet link 3. The second console 2 can achieve complete access to the radio circuits 10-12 through the first console 1 as long as both consoles 1 and 2 are connected to the Ethernet link 3. As seen in Table 1, the configuration of the two consoles 1 and 2, assuming, for example, a total of eighteen available telephone lines, is essentially the same. The base Multicast address (225.8.11.81) and each of the port numbers for both transmit and receive is the same for each console. The Time to Live value is set at 1.

TABLE 1

| | | | TTL (time to |
|---|---|---|---|
| Line # | RX Port | TX Port | live) |
| one | 1054 | 1072 | 1 |
| two | 1055 | 1073 | 1 |
| three | 1056 | 1074 | 1 |
| four | 1057 | 1075 | 1 |
| five | 1058 | 1076 | 1 |
| six | 1059 | 1077 | 1 |
| seven | 1060 | 1078 | 1 |
| eight | 1061 | 1079 | 1 |
| nine | 1062 | 1080 | 1 |
| ten | 1063 | 1081 | 1 |
| eleven | 1064 | 1082 | 1 |
| twelve | 1065 | 1083 | 1 |
| thirteen | 1066 | 1084 | 1 |
| fourteen | 1067 | 1085 | 1 |
| fifteen | 1068 | 1086 | 1 |
| sixteen | 1069 | 1087 | 1 |
| seventeen | 1070 | 1088 | 1 |
| eighteen | 1071 | 1089 | 1 |

Alternatively, the two consoles 1 and 2 can be connected in parallel at the analog level. Both consoles 1 and 2 would have control of each line 4-9 and have the ability to monitor transmissions originating at the other console. However, assuming that an Ethernet link 3 is also to be used, only one of the consoles can be on the Ethernet at any given moment. Otherwise, when audio traffic is received on radio 10, for example, both consoles 1 and 2 would create Ethernet traffic for the same audio signal. Further, each console would be creating packets with the same multicast destination address and port. Any other consoles utilizing the network would be unable to decode the IP traffic into recognizable audio. In order for an analog parallel console connection to be practical, only one of the consoles 1 and 2 may be connected to the Ethernet at any given time. Alternatively, by disabling the Ethernet connection on all of the channels on one of the consoles, only the remaining console would generate Ethernet traffic for each channel 4-9. In practice, power may also be removed from console 2, for example, the console 2 could remained physically connected and serve as a backup in the event of a hardware failure in console 1.

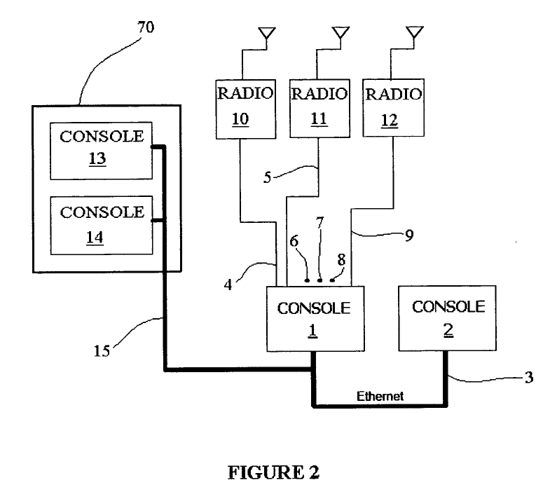

Referring also to FIG. 2, a configuration utilizing additional consoles 13 and 14 at a different location 70 is shown. Configuring the additional consoles only involves connecting them to the Wide Area Network 15 and setting the Multicast address to 225.8.11.81 for the consoles 13 and 14. The port numbers are assigned to the consoles 13 and 14 as set forth in Table 1.

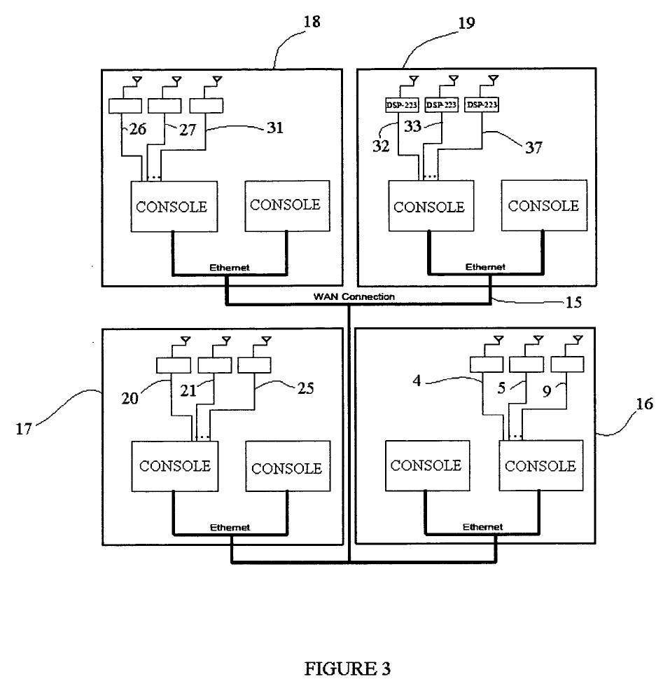

FIG. 3 depicts the situation where the number of radio circuits to be controlled exceeds the capacity of the consoles 1, 2, 13 and 14. The foregoing examples assume that each console is capable of interfacing with a maximum of eighteen lines. In those cases where more than eighteen lines exist within a radio control system, the lines can be concentrated either at a single location, or the line terminations may be spread throughout a number of floors or offices. No single console 1, 2, 13 or 14 can simultaneously control more than eighteen radio lines. However, more than eighteen lines of radio traffic can be encoded and placed upon the Ethernet network 15. By configuring the port numbers correctly, any combination of receive and transmit lines can be controlled by any single console. FIG. 3 depicts, for example, four separate dispatch positions or stations 16, 17, 18 and 19. Each of these four stations is the termination point for six radios. Station 16 is the termination of the six radios circuits 4, 5, 6, 7, 8 and 9. Station 17 is the termination of radios 20 through 25, station 18 is the termination of radios 26 through 31 and station 19 is the termination point for radio circuits 32 through 37. Two consoles are located at each dispatch center 16 through 19. By placing two consoles at each dispatch location all lines 4-9 and 20-37 can be monitored simultaneously at each location. If not all channels are required at each location, a single console may be employed with only those channels of interest being mapped to that console.

As seen in Table 2, each leased line 4-9 and 20-37 is assigned a transmit (TX) and receive (RX) port number that uniquely identifies the line to the network and to the other consoles.

TABLE 2

| | | | TTL (time to |
|---|---|---|---|
| | RX Port | TX Port | live) |
| Line # (for the | | | |
| first console at | | | |
| each dispatch | | | |
| station 16-19) | | | |
| one | 1054 | 1090 | 2 |
| two | 1055 | 1091 | 2 |
| three | 1056 | 1092 | 2 |
| four | 1057 | 1093 | 2 |
| five | 1058 | 1094 | 2 |
| six | 1059 | 1095 | 2 |
| seven | 1060 | 1096 | 2 |
| eight | 1061 | 1097 | 2 |
| nine | 1062 | 1098 | 2 |
| ten | 1063 | 1099 | 2 |
| eleven | 1064 | 1100 | 2 |
| twelve | 1065 | 1101 | 2 |
| thirteen | 1066 | 1102 | 2 |
| fourteen | 1067 | 1103 | 2 |
| fifteen | 1068 | 1104 | 2 |
| sixteen | 1069 | 1105 | 2 |
| seventeen | 1070 | 1106 | 2 |
| eighteen | 1071 | 1107 | 2 |
| Line #(for the | | | |
| second console at | | | |
| each dispatch | | | |
| station 16-19) | | | |
| one | 1072 | 1108 | 2 |
| two | 1073 | 1109 | 2 |
| three | 1074 | 1110 | 2 |
| four | 1075 | 1111 | 2 |
| five | 1076 | 1112 | 2 |
| six | 1077 | 1113 | 2 |
| (lines seven | | | |
| through eighteen | | | |
| are disabled) | | | |

The port and multicast address (225.8.11.81) assigned to each pair of the consoles at each dispatch location 16-19 is the same. The connection of the eighteen analog lines to each of the four consoles by means of line cards determines where each radio is actually connected. The system depicted in FIG. 3 will function just as readily by connecting six analog lines to the first three line cards of each console and changing the port mapping on each console. Note that in this example, the last twelve lines are disabled on the second console at each station. When, for example, a fifth dispatch location including another console is to be added that only needs to control of eighteen of the twenty four lines, the port numbers are set to only those lines of interest, thereby providing control of those specific lines. Changing the values appearing in Table 2 allows for control of different lines as well as for mapping of the lines to different channels.

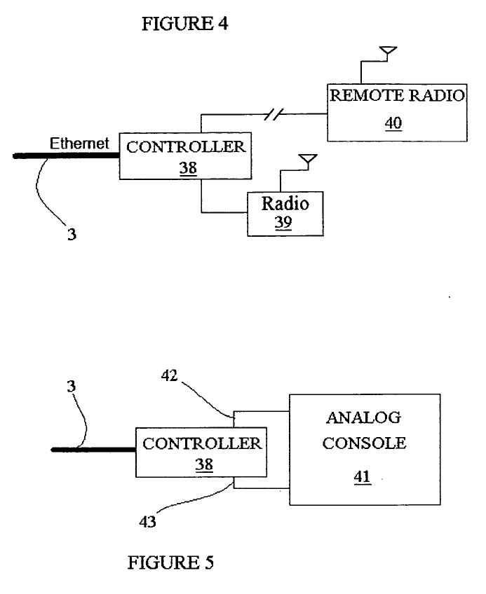

Referring also to FIG. 4, the use of a radio controller 38 can be understood. The radio controller 38 can function in three distinct modes. First, the controller can enable a connection between a local radio 39 and the Ethernet 3. A second mode of operation is to connect the controller 38 to a leased line which is connected to a radio 40. The radio 40 is left unchanged in its configuration and uses tone keying for its control. Once connected to the Ethernet 3, the controller 38 interprets data packets and sends the proper key tones to control the remote radio 40. The radio 40 is monitored for the presence of audio and the controller 38 generates IP packets. The third mode of controller operation is to replace existing console connections to radios. This mode of operation permits legacy consoles to be converted to VoIP functionality without requiring an immediate console upgrade. Any combination of the three modes can be enabled on the two ports.

In the example shown in FIG. 4, two radios 39 and 40 are controlled from a particular location by controller 38. In this case, the radio 39 is located with the controller 38 and is thus controlled locally. The second radio 40 is located at another location and is controlled by tones. The analog lines for radio 40 are terminated at the location of the controller 38 and the radio 40. The second radio 40 requires the controller 38 to generate the tones normally generated by a console. Wiring of the controller 38 is completed as either a two wire or four wire circuit. The controller 38 is configured at each of its radio control ports for the type of radio connection being utilized. As seen in Table 3, each radio control port is assigned a unique transmit and receive port number. The base multicast address is 225.8.11.81. Any console on the network 3 can then utilize the radios 39 and 40 by setting two of their lines to correspond to the port numbers enabled within the controller 38.

TABLE 3

| | Receive Port | Transmit Port | |
|---|---|---|---|
| Line Number | Address | Address | Time to Live |
| One | 1054 | 1072 | 1 |
| Two | 1055 | 1073 | 1 |

FIG. 5 depicts the conversion of legacy equipment to VoIP capability by means of the radio controller 38. A two line analog console 41 is connected to two radio ports 42 and 43. The wiring is performed by connecting the transmit and receive ports in a crisscrossed fashion. Any additional required functions of the console 41, such as cross mute and supervisory control are also connected, as well as a ground. The radio controller 38 is configured to interact with the console 41 at each of its two ports 42 and 43. The port assignments are the same as those shown in Table 3, and are not unique. The port address assignments match the radio that each line is to control. The controller 38 will then decode the tone sequence and convert the sequence into Ethernet packets of the appropriate format.

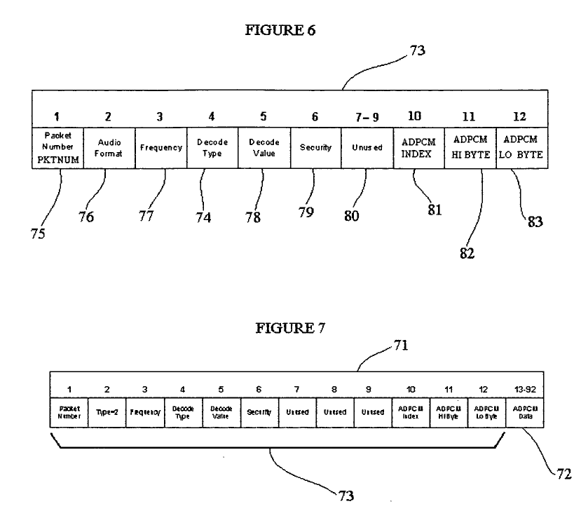

In a preferred embodiment of the present invention, the consoles 1, 2, 13 and 14, and the radio controller 38 each operate using the same data protocols. As seen in FIG. 7, the packet structure 71 consists of a total of ninety two bytes of UDP styled packet data, which is sent as multicast data. Port numbers are utilized to differentiate transmit and receive audio. The radio transmit does not need to be set up or knocked down, but rather the radio transmit is defined by the initiation and cessation of the packet stream. The packet structure utilizes the first twelve bytes as header information and the final eighty bytes (13-92) as voice or audio payload data 72. Each packet contains twenty milliseconds of audio data. The original audio is sampled at a rate of eight kilohertz (kHz) with a resolution of sixteen bits or one hundred twenty eight kilobits. An Adaptive Differential Pulse Code Modulation (ADPCM) encoder is used to compress the audio data by a factor of four resulting in an audio data stream of thirty two kilobits. The twelve bytes of header information 73 are included to help coordinate the functions of each packet.

The definition of the first twelve bytes 73 can be understood by reference to FIG. 6. The first byte 75 (PKTNUM) is an eight bit counter that gives the position of the packet number in the current data stream. No particular starting point is required. Since the counter is eight bits in length, the counter returns to zero when a value of two hundred fifty five is reached. The second byte 76 (AUDIO_FORMAT) indicates the type of audio encoding used. A value of two is used to indicate ADPCM. The third byte 77 (FREQUENCY) indicates the frequency to which the radio is set. Values between one and one hundred are typical. The value of byte 77 remains constant for a given audio transmission, and any change in value during a single transmission can cause unpredictable results. Other values that may be used for byte 77 are indicated in Table 4.

TABLE 4

| | | |
|---|---|---|
| #define MONITOR_BURST | 0x6E | |
| #define INTERCOMMTX | 0x6F | |
| #define SUPERVISOR_ON | 0x71 | |
| #define SUPERVISOR_OFF | 0x72 | |
| #define XPATCH_ON | 0x73 | /*Crosspatch On Value/* |
| #define XPATCH_OFF | 0x74 | /*Crosspatch Off Value/* |
| #define SCAN_ON | 0x75 | /*Scan Control On Value/* |
| #define SCAN_OFF | 0x76 | /*Scan Control Off Value/* |

A value of 0×6E is used to generate a monitor function. 0×6F is used to indicate an intercom function, which is similar to a Push to Talk (PTT) function except that equipment that is connected to the radio will not close a PTT relay or generate tones causing a transmission to begin. The values 0×71 and 0×72 are used to activate and deactivate the supervisor function.

In addition to the foregoing values, the Most Significant Bit (MSB) is of special interest. In audio delivery modes, a number of packets are typically buffered before audio playback begins, with six packets being the default value. This permits network jitter and disordered packets to be corrected prior to playback. Since the buffer is filled before playback begins, six packets are stored before the first packet is forwarded for processing. By setting the MSB (bit seven) of byte 77 to a value of one, the queuing process is avoided. For example, when a console transmits a function burst because a radio frequency has been changed, only two packets are sent in which bit seven is set. Since the packet bypasses the inbound queues, the frequency value is updated more quickly.

The fourth byte 74 and the fifth byte 78 (DECODE) indicate whether or not a DTMF digit was decoded at the analog interface. Byte 74 (TYPE) will have a value of one if a digit is currently being decoded and byte 78 will contain the actual value of the digit. In the preferred embodiment of the present invention, the sixth byte 79 is used for security purposes and the block 80 containing the seventh, eighth and ninth bytes remain unused and are available for future expansion.

The tenth byte 81 indicates the status of the ADPCM_INDEX and is sent in every packet in order to give the ADPCM decoder a starting position for decoding the attached audio packet. If a packet is lost by the network, byte 81 helps assure acceptable audio quality. Within the ADPCM software is a structure of the type adpcm_state. Byte 81 is the index member of that structure. The eleventh byte 82 and the twelfth byte 83 are the remaining portion of the adpcm_state structure known as the .valprev member. ADPCM is a computation based on the difference between two samples. Hence, the starting value of each of the two compared audio packets is required. Byte 82 is the most significant byte and byte 83 is the least significant byte.

Bytes thirteen through ninety two contain the actual audio payload data 72 and are the last eighty bytes of each packet 71. A typical decoder operation involves receiving the entire packet 71, utilizing the values within the header 73 to determine the type of packet that is present, setting the adpcm_state values accordingly and then executing the ADPCM decoding routine. Conversely, the encoding process typically involves sampling the hardware to generate a pulse code modulated block of audio. The adpcm_state is set as the output of the previous ADPCM encode process and the PCM samples are forwarded to the ADPCM encoding routine.

Referring also to FIG. 8, the format of Automatic Numerical Identification (ANI) packet 84 is described. The first byte 85 identifies the position of the packet 84 within the data stream and has a value of between zero and two hundred fifty five. This identifier is used for positioning of the packet in the incoming receive buffer. The second byte 86 has a value of six, indicating that the type of packet is indeed an ANI packet. The data block 87 containing the next seven bytes is the decimal representation of the ANI. Some radios will not use all of the digits and the digits that are present will be shifted to occupy the right most digit positions. The decimal ANI value is expressed using the American Standard Code for Information Interchange (ASCII) for the digits zero through nine and must be converted accordingly. If the radio supports the function, the tenth byte 88 is used to indicate an emergency condition. The emergency condition is typically initiated by the radio user and broadcast along with a voice message. The value of byte 88 is zero for normal operation and is assigned an ASCII value of “E” when used to indicate an emergency.

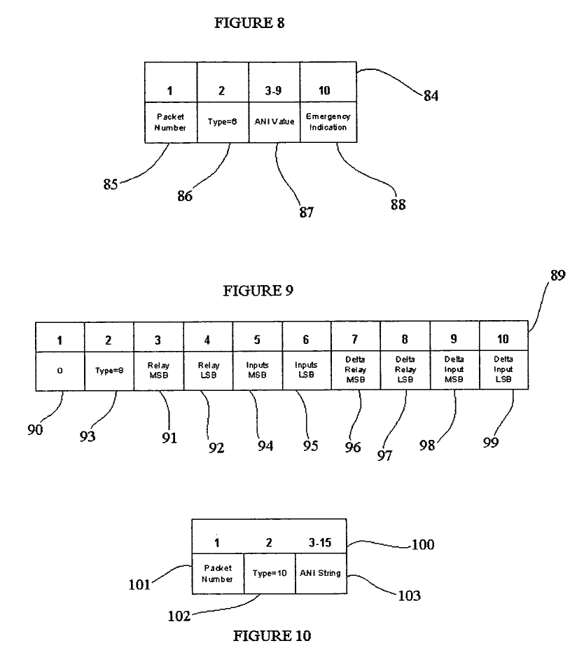

An additional device can be added to a system containing ten relays and ten diode blocked inputs for the purpose of allowing each console to remotely control and monitor devices such as doors, lights and alarms. The present invention features a packet format that permits the use of a multicast packet burst to indicate input/output (I/O) status changes of network based relays and inputs. Each input/output (I/O) device transmits a packet burst whenever its relays are operated or an input changes its state. This permits all console users on a network to observe each status change in real time. FIG. 9 illustrates the format of input/output (I/O) packet 89. The first byte 90 is not used and has a value of zero. The third byte 91 and the fourth byte 92 indicate the position of a particular relay that is being monitored. The second byte 93 has a value of eight which indicates that the packet 89 is of the type NEO I/O update. In each bit of byte 91 is an indication of whether or not the relay is energized. Bit zero indicates the status of the first relay, bit one is the status of the second relay and bit seven is the status of relay number eight. The fourth byte 92 contains in the two least significant bits (LSB) which indicate the status of relays nine and ten.

The fifth byte 94 and the sixth byte 95 indicate the status of the ten available inputs. Byte 94 contains the input value of inputs one through eight. Bit zero is the input status of input one, while bit seven indicates the status of input seven. A value of zero indicates a low state and a value of one indicates a high state. Byte 95 contains information for inputs nine and ten in the least significant bits.

Bytes 96, 97, 98 and 99 are devoted to bits that have changed value since the occurrence of the last update. The NEO monitors the inputs and relays that have changed values, and notifies the consoles of any change that has occurred. This relieves each console of the burden of having to individually monitor input and relay status changes within the NEO. Bytes 96 and 97 indicated the presence of changed relay status while bytes 98 and 99 are the changed input values.

Controlling the NEO relays is accomplished by creating a TCP/IP socket to port number 4245 of the console or radio controller. Five bytes are sent to change the state of a relay. The first byte is an ASCII “R”, the second identifies the relay number (one through ten), and the third byte is the desired state of the relay. A value of zero is “off” and a value of one is “on”. The last two bytes are a single sixteen bit value indicating the amount of time that the relay should be activated, given in milliseconds. A value of zero latches the relay in an “on” state. Another feature permits the transmission of an out of range relay number such as eleven, for example. This out of range transmission causes the NEO to broadcast the status of its relays and inputs with the changed bits indication appearing as all “ones”. This permits a console at startup to determine the status of all inputs and relays.

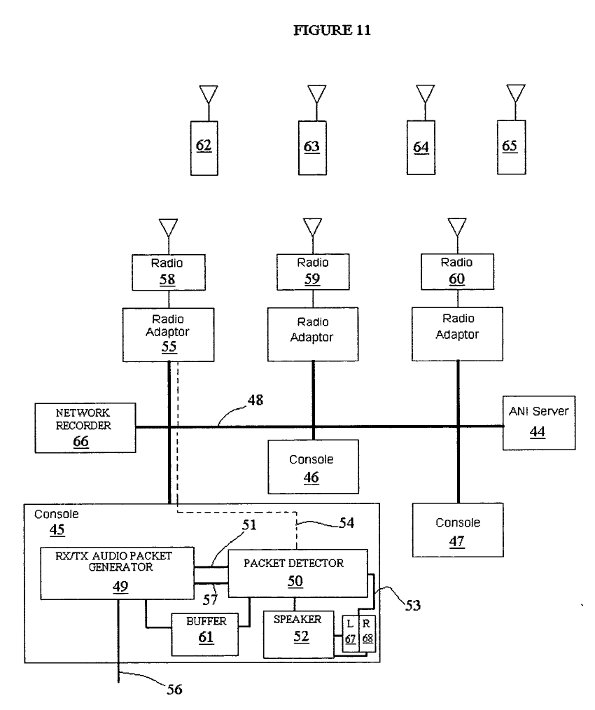

The format of the ANI lookup packet 100 is depicted in FIG. 10 and a complete radio control system embodying the principles of the present invention is shown in FIG. 11. The ANI packet type 84 permits a central ANI server 44 to perform all alias table management and lookup functions for all of the consoles 45, 46 and 47 present on the network 48. When a console 45, for example, receives the ANI lookup packet 84, the console 45 will immediately display the alphanumeric string contained in the packet as automatic numerical identification information which can be used for other messaging broadcasts. The first byte 101 of the ANI lookup packet 100 is a counter that identifies the packet position within the data stream and can have a value of between zero and two hundred fifty five. The second byte 102 has a value of ten and causes the packet to be recognized as an ANI lookup packet. The data block 103 contains the remaining thirteen bytes which are the actual alphanumeric string that is to be displayed by the console 45.

The packet structure of the present invention permits the implementation of several novel features. For example, instead of employing a dedicated echo canceller in the digital signal processor of a console, for phone line control, the actual audio packet is detected within the console transmit packets emanating from transmit audio packet generator 49. Upon detecting the transmitted audio packets 51, the packet detector 50 mutes the received audio output 53 that would otherwise be forwarded to the speaker 52. The echo is suppressed and a three fourths duplex form of communication is created. That is, when the operator of the console 45, for example, is transmitting, the operator is unable to hear received audio 54 originating from another radio connection 55, for example, because the receive path packets 54 are momentarily muted. The received audio 54 emanating from an analog telephone line 56 is also continuously monitored and receive audio packets 57 are only generated when audio activity is actually detected. Thus, in the presence of receive audio the console operator is still able to control, if necessary, the push to talk functions of any cross patched radios.

As mentioned earlier, certain console functions such as selecting a new frequency on remote radios 58, 59 and 60, for example, or initiating the monitoring of a remote radio, or activating and deactivating scanning and cross patching of a remote radio have been previously performed by sending long data streams intended to exceed the jitter buffer length and thereby guarantee that other parallel consoles would detect and process the appropriate command. The method of marking control packets as described herein permits the packet detector 50 to differentiate control packets from audio packets and thus eliminates audio delays introduced by the presence of the jitter buffer 61. The most significant bit of the Frequency byte is utilized to signify a command that is to be processed independently of the jitter buffer. By bypassing the jitter buffer 61, which has a programmable length on any given console 45, 46 and 47, the need to transmit thirty or more data packets in order to guarantee that parallel devices detect the command is eliminated. The present packet detection scheme permits the transmission of only three packets in order to ensure that one packet is received. For example, if console 45 sends a command to alter the frequency of radio 58, consoles 46 and 47 will update their respective displays to show that radio 58 is now on a different channel without the need for the updated data to pass through the jitter buffer 61.

Bypassing the jitter buffer 61 for nonaudio packet data permits the use of a redundant multicast packet burst to activate and deactivate a radio scanning function. When the scanning function is activated in a remote radio 58, 59 or 60, for example, the radio will attempt to detect a carrier on all of the programmed channels and not just the channel currently being monitored. Upon detecting an audio signal, the radio will unsquelch and forward the audio to the speaker. In the present invention, a three packet transmission sequence is used with the Frequency values of 0×75 and 0×76 for activating and deactivating, respectively, the radio scanning function. The most significant bit (MSB) is set to notify receiving units of the packet signaling content, thereby permitting the radios to start and stop the scanning function and to permit parallel consoles to indicate that the scanning function is active for a particular radio. For example, when the operator of console 45 wishes to activate the scanning function of radio 58, a control packet burst of several packets is transmitted. A single burst containing multiple packets is sufficient to activate (or deactivate) the scanning function. The parallel consoles 46 and 47 will monitor and detect this packet burst and update their displays accordingly.

Similarly, a multicast packet burst with redundant transmission is used to signal other consoles that a line is in use by a crosspatch. The crosspatch “on” byte has a frequency value of 0×73 and the crosspatch “off” byte has a frequency value of 0×74. These two bytes are used to notify parallel consoles that a line is in a crosspatch and therefore parallel consoles are prevented from accessing those lines until the crosspatch is released. A three packet sequence is transmitted with a fixed signaling bit. For example, when the operator of console 45 wishes to connect radio 58 to radio 59, that is, to crosspatch radios 58 and 59, the operators of consoles 46 and 47 must be prevented from transmitting on either radio 58 or 59. By monitoring and detecting the crosspatch initiation packet burst the parallel consoles 46 and 47 prevent their operators from transmitting on either radio 58 or 59 until the operator of radio 45 releases the crosspatch.

The second byte 86 of the ANI packet 84 has a value of six. The ANI packet 84 is used to transport ANI information that is received and decoded at each radio 58, 59 and 60, and send that information as part of the audio stream for the consoles 45, 46 and 47 to display. For example, a field based radio subscriber 62 is able to send a data burst at the beginning or end of a transmission that includes a unique number, the ANI, which identifies the user 62. The ANI is decoded and sent over the network 48 so that a number or cross referenced name can be displayed on the consoles 45, 46 or 47. In this manner, the dispatcher at each console is made aware of the name of the person making the transmission from the field.

The second byte 102 of the ANI lookup packet 100 has a value of ten. The lookup packet 100 retrieves the automatic numerical identification information from ANI server 44 and enables the broadcast of an alphanumeric user name. Generally, console users do not wish to see only a numeric identifier to identify a remote radio user. A lookup table is typically stored within each console that allows each console to automatically replace the numeric identifier with a more meaningful alphanumeric string. Unfortunately, the typical console has limited memory to devote to the storage and lookup task, and it is unlikely that a network administrator would wish to maintain the same cross reference data on multiple consoles. The use of the ANI server 44 permits the use of a single lookup of all aliases. Upon finding the alias on the server 44, the ANI lookup packet is transmitted which actually contains the alphanumeric alias contained in the ANI packet. The consoles 45-47 detect the ANI lookup packet (because the second byte has a fixed value of ten) and extract the alphanumeric data from bytes three through fifteen for display. This feature of the present invention centralizes the alias table and eliminates the need for each individual console to store and retrieve alias information. For example, when a large number of radio users are present in a system, including users 62, 63, 64 and 65, for example, the amount of ANI data that must be maintained in a cross reference table is substantial. Since each console 45, 46 and 47, for example, may have a different configuration, the addition of a new user to the system may require each console to be individually updated. When a subscriber 62, for example, makes a radio transmission, his ANI is sent to and decoded by radio 58. The radio 58 then sends an ANI packet onto the network 48 with the decoded ANI numeric identifier. The consoles 45, 46 and 47 are programmed to ignore the ANI packet. The ANI server 44 detects the ANI packet and retrieves the actual user name residing within the server database. The ANI server 44 then transmits an ANI lookup packet which each console is then able to display.

Another feature of the present invention is to provide positional recording by accessing the audio output 50 interconnected to the individual console speaker 52 and creating a VoIP stream directed via UDP to a network recorder 66. Instead of recording all radio traffic for archival and evidentiary purposes, a need sometimes arises to record exactly what a dispatcher heard from an individual speaker 52. The transmitted audio packets 51 are stored by the network recorder 66 as the packets are forwarded to the radios 58, 59 and 60. Since the transmitted audio 51 is controlled by the console operator, there was previously no mechanism for the recording system 66 to denote what the console operator was able to hear at any given moment. In the present invention, rather than having a dedicated line from each console speaker 52 to the network recorder 66, a VoIP stream is sent from the console 45 to the recording system 66 for each speaker that is to be recorded. Left channel speaker audio 67 is denoted as “select” audio and is sent to the network 48 as one VoIP stream. The right channel speaker audio 68 is designated as the “deselect” audio and is sent as a second VoIP stream. This arrangement permits recording of one side or “half” of a telephone call. Only the microphone audio must be retrieved from the network recorder 66 in order to reconstruct a complete full duplex conversation.

Recording of radio control functions, such as frequency changes, scan settings, crosspatch connections and supervisory control, for both IP and analog based consoles connected to the IP network 48, is possible. Prior recording systems are typically based on analog inputs of audio which are stored either directly to magnetic tape or digitized. The digitized information is typically stored on a computer hard drive and later archived to a compact disc read only memory or other permanent storage format. The novel data packet structure of the present invention permits the storage of audio and data such as the ANI of the radio user, the time and nature of any frequency changes, crosspatch status and timing, supervisory control status and timing, scanning status and timing, telephone caller identification information, I/O updates and other data appearing on the network 48. By decoding the unique information contained in the present packet structure, substantially more information is available to the network recorder 66 than has previously been available.

The foregoing features are intended to be illustrative of the features that may be implemented according to the principles of the present invention. However, such features should not be considered to be an exhaustive recitation of all possible features that may be implemented in a system configured in accordance with embodiments of the invention disclosed herein.

What is claimed is:

1. A data processing system for controlling at least one radio interconnected to a data processing network, comprising:
a communication interface for acquiring data comprising audio signals and control signals from the radio and the network;
a console interconnected to the communication network, the console being adapted to send and receive data to the communication interface via the network; and
a detection processor for detecting the data and differentiating between the audio and control signal components contained within the data.

2. A data processing system according to claim 1, including
an audio signal processor for converting the audio signals into an audible sound, the detection processor being adapted to prevent audio signals received by the console from reaching the audio signal processor when audio signals are being generated by the console.

3. A data processing system according to claim 2, including
a buffer for storing and presenting the data to the audio processor, the detection processor being adapted to prevent control signals from being interconnected to the buffer, thereby permitting relatively more rapid access of the control signals to the network.

4. A data processing system according to claim 3, wherein each audio signal comprises a plurality of audio packets, each audio packet including a header portion and an audio payload portion.

5. A data processing system according to claim 4, wherein each header portion is formed as a series of bytes including a signaling bit, the signaling bit being adapted to notify a device receiving the audio packet of a signaling characteristic of the audio packet

6. A data processing system according to claim 5, wherein
the signaling characteristic of the audio packet comprises at least one of, (a) a scanning activation signal, (b) a scanning deactivation signal, (c) a crosspatch activation signal, (d) a crosspatch deactivation signal.

7. A data processing system according to claim 6, further comprising
an automatic numerical information packet, the automatic numerical information packet comprising
a first byte, the first byte indicating the packet number;
a second byte, the second byte identifying the automatic numerical information packet as an automatic numerical information packet; and
a plurality of subsequent bytes, the plurality of subsequent bytes containing an automatic numerical identification value associated with the user making a transmission containing the automatic numerical information packet.

8. A data processing system according to claim 7, further comprising
an automatic numerical information lookup packet, the automatic numerical information lookup packet comprising
a first byte, the first byte indicating the packet number;
a second byte, the second byte identifying the automatic numerical information lookup packet as an automatic numerical information lookup packet; and
a plurality of subsequent bytes, the plurality of subsequent bytes containing an automatic numerical identification string that identifies a user making a transmission containing an automatic numerical information packet.

9. A data processing system according to claim 8, further comprising an input/output status packet comprising
a second byte, the second byte identifying the input/output (I/O) packet as an input/output (I/O) packet; and
a plurality of subsequent bytes, the plurality of subsequent bytes containing information as to the changes in the input/output (I/O) status of the device.

10. A data processing system according to claim 9, further comprising an ANI server, the ANI server being interconnected to the network, wherein the ANI server stores at least one cross reference table responsive to the automatic numerical information lookup packet, the ANI server providing an alphanumeric identification string in response to an automatic numerical information lookup packet.

11. A data processing system according to claim 10, further comprising an audio packet recorder, the audio packet recorder being interconnected to the network, the audio packet recorder being adapted to store selected data contained within an audio packet, the selected data being representative of audio data transmitted and received by the console.

12. A method for processing raw data streams produced by a radio monitoring device, wherein the raw data streams are processed by performing the following:
inputting the raw data streams to a packet detector having processing means capable of dividing each raw data stream into at least a control component and an audio component;
forwarding the control component to a device capable of detecting the control component so as to bypass audio processing and buffering; and
forwarding the audio component to a buffer and an audio processor.

13. A method according to claim 12, further comprising:
generating a plurality of audio data streams, each data stream characterizing audio data present at a selected audio reproduction device.

14. A method according to claim 13, further comprising:
recording substantially all of the audio and control components to a network recorder; and
identifying at least one byte value within each packet that excludes at least a portion of the packet from subsequent audio processing.

15. A method according to claim 14, further comprising:
the audio processor muting a selected audio reproduction device in response to detecting that a first audio signal is being generated for transmission while a second audio signal is being received by the audio processor.

16. A method according to claim 15, further comprising:
generating control packets having no audio component; and
identifying each control packet with a bit indicating that the control packet contains a specific type of nonaudio data.

17. A method of reducing data transmission and storage requirements in a radio monitoring and control system used for transmitting and receiving radio transmissions via an intemet protocol (IP) network, comprising:
separating substantially all data values present in a data packet into header information and audio payload information;
assigning a relative contribution value to each data value present in the signal;
identifying each data packet as one of (a) a data packet containing at least some audio payload information and (b) a data packet containing no audio payload information, thereby creating a set of data packets that are excluded from audio processing;
redundantly multicasting each data packet having no audio payload information over the IP network for less than four repetitions; and
controlling selected radio functions by means of data packets having no audio payload information.

18. A method according to claim 17, further comprising controlling a scanning function of a radio by redundantly multicasting each data packet having no audio payload information over the IP network for less than four repetitions.

19. A method according to claim 18, further comprising controlling a cross patching function of at least one radio by redundantly multicasting each data packet having no audio payload information over the IP network for less than four repetitions.

20. A method according to claim 19, further comprising transmitting an input/output update packet to the IP network to indicate a status change of binary devices associated with equipment interconnected to the IP network.
